(19) United States
(12) Patent Application Publication
(10) Pub. No.: US 2026/0229605 A1
(43) Pub. Date: Aug. 6, 2026

(54) METHOD OF FABRICATING AN ALL-SOLID-STATE BATTERY HAVING A SHEET-TYPE SOLID ELECTROLYTE

(71) Applicant: UT-Battelle, LLC, Oak Ridge, TN (US)

(72) Inventors: Guang Yang, Knoxville, TN (US); Chanho Kim, Knoxville, TN (US)

(21) Appl. No.: 19/464,950

(22) Filed: Jan. 30, 2026

Related U.S. Application Data
(60) Provisional application No. 63/752,563, filed on Jan. 31, 2025.

(51) Int. Cl. H01M 10/0585; H01M 4/02; H01M 4/04; H01M 4/1391; H01M 4/1395; H01M 4/38; H01M 4/525; H01M 4/62; H01M 10/0562

(52) U.S. Cl. CPC H01M 10/0585; H01M 4/0435; H01M 4/1391; H01M 4/1395; H01M 4/386; H01M 4/525; H01M 4/623; H01M 4/625; H01M 10/0562; H01M 2004/021; H01M 2004/027; H01M 2004/028; H01M 2300/0068

(57) ABSTRACT

A method of fabricating an all-solid-state battery is provided. The method includes forming a silicon-based anode layer by wet processing a first mixture including microsilicon particles having an average particle size in a range of 0.1 to 100 μm. The silicon-based anode layer has a thickness in a range of from 1 to 200 μm. The method further includes forming a sulfide solid-state electrolyte (SSE) film by wet or dry processing a second mixture. The sulfide SSE film has a thickness in a range of from 0.5 to 100 μm. The method further includes forming a cathode layer by dry processing a third mixture. The cathode layer has a thickness in a range of from 1 to 200 μm. The method further includes combining the silicon-based anode layer, the sulfide SSE film, and the cathode layer.

### CROSS-REFERENCE TO RELATED APPLICATIONS

This application claims the benefit of U.S. Provisional Application No. 63/752,563, filed Jan. 31, 2025, the disclosure of which is incorporated by reference in its entirety.

### STATEMENT REGARDING FEDERALLY SPONSORED RESEARCH AND DEVELOPMENT

This invention was made with government support under Contract No. DE-AC05-00OR22725 awarded by the U.S. Department of Energy. The government has certain rights in the invention.

### FIELD OF THE INVENTION

The present invention relates to all-solid-state batteries and a method of fabricating an all-solid-state battery.

### BACKGROUND OF THE INVENTION

Future energy storage systems, such as for electric vehicles (EVs), will require a high energy density to store the maximum amount of energy within a given weight and volume. A critical factor is the effective stacking of unit battery cells in actual modules, which not only reduces the overall volume but also minimizes weight by eliminating non-essential components. For this reason, all-solid-state batteries (ASSBs) utilizing solid-state electrolytes are a promising next-generation energy storage system. Compared to traditional liquid electrolyte systems, ASSBs enable easier stacking, and the weight of inactive materials such as tabs, packing bags, and current collectors can be minimized by employing bipolar plates to stack multiple cells. Therefore, the development of materials, processes, and systems for ASSBs may be useful towards the maximization of energy density.

Lithium metal is one type of anode material for ASSBs having high energy density due to its high theoretical capacity and low electrochemical potential. However, the issue of lithium dendrite formation through the solid electrolyte during operation has hindered the stable operation of lithium-based ASSBs and has posed safety and reliability issues that have led to cell failure and are an obstacle to commercialization. Silicon, with its high theoretical capacity and low electrochemical potential, is another type of anode material. Unlike lithium metal, which is prone to dendrite formation, silicon operates through an alloying reaction with lithium ions to form LiₓSi, making it relatively free from dendrite issues. However, despite these advantages, severe volume expansion during operation has led to unstable solid-electrolyte interphase (SEI) formation and repeated breakdowns in traditional liquid electrolyte systems, causing pulverization of the silicon and limiting its application. A solid electrolyte can prevent silicon pulverization and enable a stable SEI to be formed at the solid electrolyte interface, making silicon a suitable anode material when incorporated with solid electrolytes. Particularly, sulfide-based solid electrolytes such as Li₆PS₅Cl (LPSCl) and Li₁₀GeP₂S₁₂ (LGPS) are considered suitable systems due to their ductile nature, which allows them to accommodate the stress caused by volume changes in the anode during operation.

For these reasons, the application of silicon anodes to sulfide type ASSBs has been considered. In general, there are two types of Si anodes used in ASSBs: composite Si anodes and pure Si anodes. The former are composed of a certain amount of sulfide solid-state electrolyte (SSE) and carbon additives. Owing to the instability of the sulfide SSE to moisture and most polar solvents, it requires careful processing with non-polar solvents and a demanding environment. The use of additional non-active materials (i.e., SSEs and carbon) in the anode inevitably reduces the cell energy density. For example, study of the performance of silicon-carbon composite anodes in a sulfide ASSBs has revealed that the presence of a significant amount of inactive material in the electrode and the simple powder processing used to form the cathode results in a low loading level, limiting the energy density to 285 Wh·kg⁻¹. Hence, ASSBs using silicon-only anodes may be more effective, and a need continues to exist for improved ASSBs with silicon-only anodes having improved energy density.

### SUMMARY OF THE INVENTION

A method of fabricating an all-solid-state battery is provided. The method includes forming a silicon-based anode layer by wet processing a first mixture including microsilicon particles having an average particle size in a range of 0.1 to 100 μm. The silicon-based anode layer has a thickness in a range of from 1 to 200 μm. The method further includes forming a sulfide solid-state electrolyte (SSE) film by wet or dry processing a second mixture. The sulfide SSE film has a thickness in a range of from 0.5 to 100 μm. The method further includes forming a cathode layer by dry processing a third mixture. The cathode layer has a thickness in a range of from 1 to 200 μm. The method further includes combining the silicon-based anode layer, the sulfide SSE film, and the cathode layer.

In specific embodiments, the first mixture further includes lithium added to the microsilicon particles to form lithium-silicon alloy particles, and a molar ratio of lithium to microsilicon is from greater than 0 to 90:10.

In specific embodiments, the silicon-based anode layer, the sulfide SSE film, and the cathode layer further includes one of: i) laminating the silicon-based anode layer, the sulfide SSE film, and the cathode layer together; ii) press-combining two of the silicon-based anode layer, the sulfide SSE film, and the cathode layer together, and then adding the other of the silicon-based anode layer, the sulfide SSE film, and the cathode layer; or iii) transfer-printing the sulfide SSE film onto either the silicon-based anode layer or the cathode layer, and then adding to other of the silicon-based anode layer or the cathode layer.

In specific embodiments, the first mixture includes further includes a polymeric binder comprising a fluoropolymer component, wherein a CF2-to-CH2 molar ratio of the binder is from greater than 0:100 to 100:0.

In specific embodiments, the first mixture further includes a solvent that includes one or more of an aqueous solvent, a polar aprotic organic solvent, and an ether solvent.

In particular embodiments, the solvent is selected from the group consisting of N-methyl-2-pyrrolidone (NMP), N,N-dimethylformamide (DMF), N,N-dimethylacetamide (DMAc), dimethyl sulfoxide (DMSO), water (H₂O), 1,2-demethoxyethane (DME), 1,3-dioxolane (DOL), diethylene glycol dimethyl ether (diglyme), triethylene glycol dimethyl ether (triglyme), tetraethylene glycol dimethyl ether (tetraglyme), 2-methyltetrahydrofuran (2-MeTHF), tetrahydrofuran (THF), diethyl ether (DEE) and mixtures thereof.

In specific embodiments, the microsilicon particles comprise at least 10 wt. % silicon and up to 99.9 wt. % silicon.

In specific embodiments, the microsilicon particles have a broad particle size distribution such that D90/D10≥3.

In specific embodiments, the step of wet processing the first mixture includes slurry casting the first mixture onto a substrate.

In specific embodiments, the second mixture includes a binder selected from a group of nitrile butadiene rubber (NBR), hydrogenated nitrile butadiene rubber (HNBR), polyisobutylene (PIB), poly(butyl methacrylate) (PBMA), styrene-butadiene-styrene (SBS), styrene-ethylene/butylene-styrene (SEBS), and styrene-butadiene rubber (SBR).

In specific embodiments, the second mixture includes argyrodite.

In specific embodiments, the second mixture includes an anhydrous, nonpolar solvent or a low-polarity organic solvent.

In particular embodiments, the solvent includes one or more of toluene, n-heptane, n-hexane, cyclohexane, decalin, a C10-C14 alkane, a xylene, anisole, isobutyl isobutyrate, mesitylene, ethylbenzene, and an isoparaffinic hydrocarbon.

In specific embodiments, the step of wet processing the second mixture includes slurry casting the second mixture onto a substrate to obtain an intermediate film, and densifying the intermediate film by subjecting the intermediate film to a plurality of passes through a roller press at a temperature in a range of from approximately 20 to 700° C. to obtain the sulfide SSE film.

In specific embodiments, the SSE film has a strain-hardening property such that an indentation stress increases with indentation strain over an indentation strain interval from 0.2 to 1.

In particular embodiments, the strain-hardening property has a positive work hardening slope, dσ/dε >0, over at least 0.1 of the indentation strain within the interval from 0.2 to 1.

In particular embodiments, the indentation stress at an indentation strain of 1 is at least 1.1 times the indentation stress at an indentation strain of 0.2.

In specific embodiments, the third mixture includes: i) a coated layered oxide cathode active material comprising a lithium nickel manganese cobalt oxide (NMC) of formula LiNiₓMn_{y}Co_{z}O₂, where x+y+z=1 and 0<x<1, the cathode active material having a surface coating comprising one of a lithium-containing inorganic coating layer, a lithium-containing metal oxide coating layer, or a niobium-containing lithium oxide coating layer; ii) a sulfide catholyte comprising Li₆PS₅Cl (LPSCl); iii) a conductive carbon material selected from a group of carbon fibers, vapor-grown carbon fibers, carbon black, acetylene black, Ketjenblack, graphite, graphene, carbon nanotubes, carbon nanofibers, and mixtures thereof; and iv) a polymeric binder selected from a group of polytetrafluoroethylene (PTFE), poly(vinylidene fluoride) (PVDF), poly(vinylidene fluoride-co-hexafluoropropylene) (PVDF-HFP), fluorinated ethylene propylene (FEP), ethylene-tetrafluoroethylene (ETFE), nitrile butadiene rubber (NBR), hydrogenated nitrile butadiene rubber (HNBR), styrene-ethylene/butylene-styrene (SEBS), styrene-butadiene-styrene (SBS), polyisobutylene (PIB), poly(butyl methacrylate) (PBMA), and mixtures thereof.

In particular embodiments, the third mixture comprises, based on a total weight: i) approximately 50 to 95 wt. % of the coated layered oxide cathode active material; ii) approximately 3 to 25 wt. % of the sulfide catholyte; iii) approximately 0.5 to 10 wt. % of the conductive carbon material; and iv) approximately 0.1 to 5 wt. % of the polymeric binder.

In particular embodiments, the step of dry processing the third mixture comprises: i) dry mixing the cathode active material, the sulfide catholyte material, the conductive carbon material, and the polymeric binder to form a first blended powder; ii) homogenizing the first blended powder to form a homogenized composite; iii) forming the homogenized composite into a free-standing film by rolling; and iv) pressing the free-standing film to densify the film thereby forming a cathode film.

In certain embodiments, the step of homogenizing the first blended powder comprises applying shear and/or compressive deformation to distribute the conductive carbon material and the polymeric binder substantially uniformly throughout the third mixture.

In certain embodiments, i) the step of homogenizing the first blended powder is performed at a temperature in a range of from approximately −196 to 300° C.; ii) the step of rolling the homogenized composite is performed at a temperature in a range of from approximately 15 to 120° C.; and iii) the step of pressing the free-standing film is performed at a temperature in a range of from approximately 20 to 500° C. and at a pressure in a range of from approximately 1 MPa to 300 MPa for a time period in a range of from approximately 1 second to 60 minutes.

An all-solid-state battery obtained by the method is also provided.

In specific embodiments, the all-solid-state battery has an energy density of at least approximately 300 Wh/kg at a temperature in a range of from approximately 25 to 200° C.

These and other features of the invention will be more fully understood and appreciated by reference to the description of the embodiments and the drawings.

### BRIEF DESCRIPTION OF THE DRAWINGS

FIG. 1 is a schematic view of a method of fabricating an all-solid-state battery in accordance with embodiments of the disclosure;

FIG. 2 is a graph of a voltage profile of a full Si|LPSCl|NMC811 battery cell in accordance with embodiments of the disclosure with an NMC 811 mass loading of 13.4 mg cm⁻¹ at 25° C. under varying current densities;

FIG. 3 is a graph of rate capability evaluation results for the Si|LPSCl|NMC811 cell with an NMC 811 mass loading of 13.4 mg cm⁻¹ at 25° C.;

FIG. 4 is a graph of a voltage profile of the Si|LPSCl|NMC811 cell with an NMC811 mass loading of 13.4 mg cm⁻¹ at 25° C. under a fixed current density of 0.05 mA cm⁻² and varying discharging current densities;

FIG. 5 is a graph of an initial cycle voltage profile of a full Si|LPSCl|NMC811 battery cell in accordance with embodiments of the disclosure with an NMC811 mass loading of 45 mg cm⁻¹;

FIG. 6 is a graph of long-cycle stability of the Si|LPSCl|NMC811 cell with an NMC811 mass loading of 13.4 mg cm⁻¹ under a current density of 1 mA cm⁻²;

FIG. 7 is a graph of long-cycle stability of the Si|LPSCl|NMC811 cell with an NMC811 mass loading of 45 mg cm⁻¹ under a current density of 1 mA cm⁻²;

FIG. 8 is a graph of long-cycle stability of a full Si|LPSCl|NMC811 battery cell accordance with embodiments of the disclosure with an NMC811 mass loading of 8.4 mg cm⁻¹ at 0.5 C;

FIG. 9 is a graph of a voltage profile of a full Si|LPSCl|NMC811 battery cell accordance with embodiments of the disclosure with an NMC811 mass loading of 19 mg cm⁻¹ at 40° C. under current densities of 0.1 to 2 mA cm⁻²;

FIG. 10 is a graph of a voltage profile of a full Si|LPSCl|NMC811 battery cell accordance with embodiments of the disclosure with an NMC811 mass loading of 25 mg cm⁻¹ at 50° C. under current densities of 0.4 to 2.8 mA cm⁻²;

FIG. 11 is a graph of a voltage profile of the Si|LPSCl|NMC811 cell with an NMC811 mass loading of 25 mg cm⁻¹ at 50° C. under current densities of 3.2 to 5.6 mA cm⁻²;

FIG. 12 is a graph of long-cycle stability of the Si|LPSCl|NMC811 cell with an NMC811 mass loading of 19 mg cm⁻¹ under a current density of 2 mA cm⁻² at 40° C.;

FIG. 13 is a graph of long-cycle stability of the Si|LPSCl|NMC811 cell with an NMC811 mass loading of 25 mg cm⁻¹ under a current density of 3.2 mA cm⁻² at 50° C.;

FIG. 14 is a graph of long-cycle stability of a full Si|LPSCl|NMC811 battery cell accordance with embodiments of the disclosure with an NMC811 mass loading of 13.2 mg cm⁻¹ at room temperature, 40° C., and 50° C.;

FIG. 15 is a graph of an initial cycle voltage profile of a full Si|LPSCl|NMC811 battery cell in accordance with embodiments of the disclosure with an NMC811 mass loading of 50 mg cm⁻¹;

FIG. 16 is of cycling performance of the Si|LPSCl|NMC811 cell with an NMC811 mass loading of 50 mg cm⁻¹ at a current density of 0.2 mA cm⁻² at 50° C.;

FIG. 17 is a graph of Electrochemical Impedance Spectroscopy (EIS) Nyquist profiles as a function of state of charge (SOC) for a full Si|LPSCl|NMC811 battery cell in accordance with embodiments of the disclosure;

FIG. 18 is a graph of EIS Nyquist profiles as a function of state of discharge (SOD) for a full Si|LPSCl|NMC811 battery cell in accordance with embodiments of the disclosure;

FIG. 19 is a graph of Equivalent Circuit Model (ECM) fitting in the Nyquist plot at 4.3V where R_{b} refers to bulk and grain boundary resistance, and Rᵢₙₜ refers to the entire interfacial resistances that cover all cathode/solid state electrolyte (CEI), solid-electrolyte interface (SEI), and charge transfer resistances from both sides;

FIG. 20 is a graph summarizing the calculated ECM fitting value for charging;

FIG. 21 is a graph summarizing the calculated ECM fitting value for discharging;

FIG. 22 is a graph of quantitative analysis results of different LiₓSi alloy phases as a function of SOC and SOD for a full Si|LPSCl|NMC811 battery cell in accordance with embodiments of the disclosure at an Si loading of 0.62 mg cm⁻²;

FIG. 23 is a graph of Differential Resistance Technique (DRT) analysis results of three-electrode Nyquist total impedance results at the 1^{st}, 12^{th}, and 16^{th} cycles;

FIG. 24 is a graph of DRT analysis results of three-electrode Nyquist separate impedance results at the 16^{th} cycle; and

FIG. 25 is a graph of DRT analysis results of a cathode side of the three-electrode cell measured every 10 cycles during the initial 30 cycles of operation.

### DETAILED DESCRIPTION OF THE CURRENT EMBODIMENTS

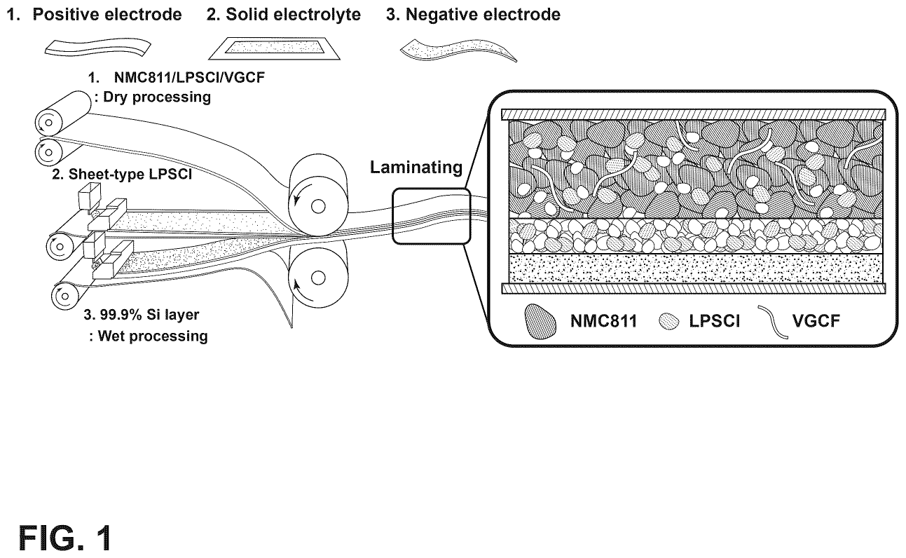

As discussed herein, the current embodiments relate to a method of fabricating an all-solid-state battery (ASSB). As generally illustrated in FIG. 1, the method includes forming a silicon-based anode layer by wet processing a first mixture, forming a solid-state electrolyte (SSE) film by wet or dry processing a second mixture, forming a cathode layer by dry processing a third mixture, and combining the silicon-based anode layer, the SSE film, and the cathode layer. Each step is separately discussed in detail below.

The step of forming the silicon-based anode layer by wet processing a first mixture includes mixing microsilicon (μmSi) particles with a solvent. The microsilicon particles may have a particle size in a range of 0.1 to 100 μm, optionally in a range of 0.1 to 50 μm, optionally in a range of from 0.1 to 25 μm, optionally in a range of from 0.1 to 10 μm, optionally in a range of from 0.1 to 5 μm, optionally in a range of from 1 to 10 μm, optionally in a range of from 1 to 5 μm. The microsilicon thus is a micrometer-sized silicon powder, in contrast to nano-sized silicon (nSi) which is not used in the method, and the microsilicon particles have a D50 (median particle size) that is greater than 0.1 μm. The microsilicon particles may also have a broad particle size distribution such that the microsilicon particles do not have to be refined particles, and the particles are present in the first mixture in a wide range of particle sizes. Particularly, the microsilicon particles may have a broad particle size distribution such that D90/D10 is greater than or equal to 3, with D90 being the particle size (in diameter) that is larger than the diameter of 90% of the particles, and D10 being the particle size (in diameter) that is larger than the diameter of 10% of the particles. The microsilicon particles may include at least 10 wt. % silicon and up to 99.9 wt. % silicon, and in some embodiments the microsilicon particles are pure or nearly pure silicon (having approximately 99.9 wt. % silicon). In exemplary embodiments, lithium may be added to the microsilicon particles in the first mixture to form a lithium-silicon alloy (LiₓSi), which is generally referred to as lithiation (or prelithiation) of the silicon. In these embodiments, a molar ratio of lithium to silicon is from greater than 0 to greater than 22:5 and up to 90:10 which represent 100% overlithiation. The lithiation may be performed, for example, by ball-milling the silicon with lithium metal, or by mixing coupled with a pressurizing step. Thus, the first mixture may contain silicon particles, or a lithium-silicon alloy, or a lithium-silicon alloy and excess lithium (i.e., a mixture of LiₓSi and Li). The solvent may be an aqueous solvent, a polar aprotic organic solvent, an ether solvent, or a combination thereof. In various embodiments, the solvent is one or a combination of N-methyl-2-pyrrolidone (NMP), N,N-dimethylformamide (DMF), N,N-dimethylacetamide (DMAc), dimethyl sulfoxide (DMSO), water (H₂O), 1,2-demethoxyethane (DME), 1,3-dioxolane (DOL), diethylene glycol dimethyl ether (diglyme), triethylene glycol dimethyl ether (triglyme), tetraethylene glycol dimethyl ether (tetraglyme), 2-methyltetrahydrofuran (2-MeTHF), tetrahydrofuran (THF), diethyl ether (DEE). The first mixture may further include a fluorinated carbonate such as, for example, fluoroethylene carbonate (FEC) as a co-solvent/additive and/or a fluorinated ether diluent such as, for example, 1,1,2,2-tetrafluoroethyl-2,2,3,3-tetrafluoropropyl ether (TTE) or bis(2,2,2-trifluoroethyl) ether (BTFE). The first mixture may also additionally include a polymeric binder that includes a fluoropolymer component, and optionally a non-fluorinated polymer component, wherein a CF₂-to-CH₂ molar ratio of the binder is from greater than 0:100 to 100:0. The polymeric binder may be, for example, polyvinylidene fluoride (PVDF). The first mixture is slurry-casted onto a substrate to form the silicon anode. The resulting silicon anode is a thin anode having a thickness in a range of from 1 to 200 μm. In exemplary embodiments, the silicon anode has a thickness in a range of from approximately 1 to 20 μm, optionally from 1 to 15 μm, optionally 10 μm or less.

The step of forming the sulfide solid-state electrolyte (SSE) film by wet or dry processing a second mixture includes mixing a binder with an argyrodite. The argyrodite particularly may be a lithium based argyrodite-type material. Especially in the case of wet processing, the binder may be an elastomer/rubber such as, but not limited to, nitrile butadiene rubber (NBR), hydrogenated nitrile butadiene rubber (HNBR), polyisobutylene (PIB), poly(butyl methacrylate) (PBMA), styrene-butadiene-styrene (SBS), styrene-ethylene/butylene-styrene (SEBS), and styrene-butadiene rubber (SBR). The solvent may be an anhydrous, nonpolar solvent or a low-polarity organic solvent. In the case that the binder is an elastomer/rubber material, the solvent preferably may be a low-polarity solvent system. In various embodiments, for wet processing the solvent in the second mixture may be toluene, n-heptane, n-hexane, cyclohexane, decalin (decahydronaphthalene), a C10-C14 alkane (e.g., dodecane), a xylene (e.g., o-xylene, m-xylene, p-xylene), anisole, isobutyl isobutyrate (often paired with toluene as a co-solvent), mesitylene, ethylbenzene, an isoparaffinic hydrocarbon, or a combination thereof. The step of wet processing the second mixture may include slurry casting the second mixture onto a substrate to obtain an intermediate film, although the second mixture may be formed by tape casting or wet milling. The step of wet processing the second mixture may further include densifying the intermediate film by subjecting the intermediate film to a plurality of passes through a roller press at a temperature in a range of from approximately 20 to 700° C., optionally from 20 to 550° C., optionally from 20 to 500° C., to obtain the sulfide SSE film. In some embodiments, the second mixture is cold roller pressed. Densifying the film thus may be performed by applying a compressive stress, and the densification may increase an indentation stress measured at an indentation strain of 0.6 by at least 5% relative to an unconditioned film. The second mixture may also include a fluoropolymer, especially in the case of dry processing. The fluoropolymer may be polytetrafluoroethylene (PTFE), fluorinated ethylene propylene (FEP), ethylene-tetrafluoroethylene (ETFE or ETEF), poly(vinylidene fluoride) (PVDF), poly(vinylidene fluoride-co-hexafluoropropylene) (PVDF-HFP), poly(vinylidene fluoride-co-trifluoroethylene) (PVDF-TrFE), or a combination thereof. The resulting sulfide SSE film has a thickness in a range of from 0.5 to 500 μm, optionally from 0.5 to 200 μm, optionally from 0.5 to 100 μm, optionally from 0.5 to 50 μm, optionally from 0.5 to 25 μm, optionally from 0.5 to 100 μm, optionally from 0.5 to 50 μm, optionally from 1 to 100 μm, optionally from 50 to 100 μm. The resulting sulfide SSE film may have a strain-hardening property such that an indentation stress increases with indentation strain over an indentation strain interval from 0.2 to 1. Further, the indentation stress at an indentation strain of 1 may be at least 1.1 times the indentation stress at an indentation strain of 0.2. Also, the strain-hardening property may have a positive work hardening slope, dσ/dε>0, over at least 0.1 of the indentation strain within the interval from 0.2 to 1. The strain-hardening property of the sulfide SSE film advantageously may maintain a more stable electrode-to-electrolyte interface, thus providing mitigating contact loss during cycling. Particularly, the silicon-based anode layer maintains a well-defined two-dimensional solid-electrolyte interface (SEI) layer even when the silicon-based anode layer expands and contracts during cycling, due to the strain-hardening behavior of the adjacent sulfide SSE film that buffers the expansion of the silicon-based anode layer.

The step of forming the cathode layer by dry processing a third mixture includes dry mixing (i.e., without a solvent or substantially free of solvents) a cathode active material such as a coated layered oxide cathode active material, a sulfide catholyte, a conductive carbon material, and a polymeric binder. In various embodiments, the coated layered oxide cathode active material includes a lithium nickel manganese cobalt oxide (NMC) of formula LiNiₓMn_{y}Co_{z}O₂, where x+y+z=1 and 0<x<1. In exemplary embodiments, the lithium nickel manganese cobalt oxide is NMC811. The cathode active material may have a surface coating that is one of a lithium-containing inorganic coating layer, a lithium-containing metal oxide coating layer, or a niobium-containing lithium oxide coating layer. More generally, the cathode may be of a variety of types including but not limited to layered oxides (LCO) such as lithium cobalt oxide (LiCoO₂), lithium nickel manganese cobalt oxide (LiNiₓMn_{y}Co_{z}O₂) such as NMC111, NMC532, NMC622, NMC811, high-Ni NMCs (NCA) such as lithium nickel cobalt aluminum oxide (LiNiCoAlO₂), spinel oxides (LMO) such as lithium manganese oxide spinel (LiMn₂O4), high-voltage spinel (LNMO) such as lithium nickel manganese oxide (LiNi_{0.5}Mn_{1.5}O₄), olivine/polyanion cathodes (LFP) such as lithium iron phosphate (LiFePO₄), LMFP/LFMP such as lithium manganese iron phosphate (LiMnₓFe₁₋ₓPO₄), a lithium vanadium phosphate (LVP) such as Li₃V2(PO4)₃, lithium cobalt phosphate (LCP) such as LiCoPO₄, lithium-rich layered oxides (LR-NMC), lithium-rich Mn-based layered oxides, disordered rock-salts (DRX), lithium-excess/DRX materials, and conversion-type cathodes including sulfur or metal fluorides. The cathode may have a particle size in a range of from 0.5 to 50 μm and may be a bimodal or multi-modal cathode having two or more particle sizes (or size ranges). The sulfide catholyte in the third mixture may include Li₆PS₅Cl (LPSCl). The conductive carbon material in the third mixture be carbon fibers, vapor-grown carbon fibers, carbon black, acetylene black, Ketjenblack, graphite, graphene, carbon nanotubes, carbon nanofibers, or a combination thereof. The polymeric binder in the third mixture may be polytetrafluoroethylene (PTFE), poly(vinylidene fluoride) (PVDF), poly(vinylidene fluoride-co-hexafluoropropylene) (PVDF-HFP), fluorinated ethylene propylene (FEP), ethylene-tetrafluoroethylene (ETFE), nitrile butadiene rubber (NBR), hydrogenated nitrile butadiene rubber (HNBR), styrene-ethylene/butylene-styrene (SEBS), styrene-butadiene-styrene (SBS), polyisobutylene (PIB), poly(butyl methacrylate) (PBMA), or a combination thereof. Based on the total weight of the components, the third mixture may include approximately 50 to 95 wt. % of the coated layered oxide cathode active material, approximately 3 to 25 wt. % of the sulfide catholyte, approximately 0.5 to 10 wt. % of the conductive carbon material, and approximately 0.1 to 5 wt. % of the polymeric binder. The dry processing may be performed under an inert atmosphere, such as, for example, an atmosphere having less than approximately 10 ppm H₂O and less than approximately 10 ppm O₂.

In various embodiments, the dry processing of the third mixture may particularly include dry mixing the cathode active material, the sulfide catholyte material, the conductive carbon material, and the polymeric binder to form a first blended powder, followed by homogenizing the first blended powder to form a homogenized composite, forming the homogenized composite into a free-standing film by rolling, and pressing the free-standing film to densify the film thereby forming a cathode film. The sub-step of homogenizing the first blended powder may include applying shear and/or compressive deformation to distribute the conductive carbon material and the polymeric binder substantially uniformly throughout the third mixture. The homogenizing may be performed at a temperature in a range of from approximately −196 to 300° C., with the lower end of the temperature range involving the use of, for example, a cryo-mill chilled with liquid nitrogen. Optionally, the homogenizing may be performed at a temperature in a range of from approximately 20 to 80° C. The sub-step of rolling the homogenized composite is performed using a roller temperature in a range of from approximately 15 to 120° C., and at a line speed in a range of from approximately 0.01 to 10 m/minute. The rolling may include two or more rolling passes to form the free-standing film, and the rolling may be performed by calendering the homogenized composite through rollers having a gap in a range of from approximately 10 to 500 μm. The resulting free-standing film after rolling (and before pressing) may have a thickness in a range of from approximately 10 to 500 μm. In certain embodiments, the sub-step of homogenizing further includes binder fibrillation, such as fibrillating the polymeric binder to form a fibrous network that binds the cathode active material, the sulfide catholyte, and the conductive carbon material. Binder fibrillation may be particularly useful if a PTFE binder or similar is present. The sub-step of pressing the free-standing film may be performed at a temperature in a range of from approximately 20 to 500° C., optionally from 40 to 120° C., and at a pressure in a range of from approximately 1 MPa to 300 MPa for a time period in a range of from approximately 1 second to 60 minutes. The pressing may be performed uniaxially. In some embodiments, pressing the free-standing film includes hot pressing at approximately 40 to 150° C. at approximately 5 to 200 MPa for approximately 0.5 to 30 minutes. The cathode film formed by the method has a resulting thickness in a range of from 1 to 200 μm, optionally from 50 to 200 μm, optionally from 100 to 200 μm, optionally from 125 to 200 μm, optionally from 150 to 200 μm.

The all-solid-state battery fabrication method further includes combining the silicon-based anode layer, the sulfide SSE film, and the cathode layer. In some embodiments, the combining may include laminating the silicon-based anode layer, the sulfide SSE film, and the cathode layer together. Particularly, each of the layers is first formed as a free-standing layer, and then subsequently laminated together. In other embodiments, the combining may include pressing together two of the layers, e.g. the silicon-based anode layer and the sulfide SSE film, and then subsequently adding the third layer, e.g., the cathode layer, to the pressed together layers. Again, each of the layers is first formed as a free-standing layer prior to being combined with the other layers. In yet other embodiments, the combining may include transfer-printing the sulfide SSE film onto either the silicon-based anode layer or the cathode layer, e.g., the silicon-based anode layer, and then subsequently adding the third layer, e.g., the cathode layer, to the transfer-printed layers. The pressure utilized to combine the layers may be in a range of from approximately 0.1 MPa to 1000 MPa. It should also be understood that current collectors are also provided in the stack adjacent the silicon-based anode layer and the cathode layer. For example, a copper current collector may be provided adjacent the silicon-based anode layer, and an aluminum current collector may be provided adjacent the cathode layer.

The all-solid-state battery formed by the method may have an energy density of at least approximately 300 Wh/kg at a temperature in a range of from approximately 25 to 200° C. In exemplary embodiments, the all-solid-state battery has an energy density of at least 350 Wh/kg, optionally at least 380 Wh/kg, optionally at least 400 Wh/kg.

In contrast to conventional sulfide-based ASSBs utilizing silicon, the present ASSB has a relatively heavy cathode layer, indicating a higher areal capacity, and a lighter anode layer. In exemplary embodiments, this is accomplished herein by employing a thick cathode obtained through dry processing, a thin-film sulfide solid-state electrolyte formed as described above, and a slurry-casted anode comprising silicon that may be pre-lithiated and optionally overlithiated. To maximize energy density, it is preferable to fabricate thin and robust anode and solid electrolyte layers using wet processing with appropriate solvents and binders, while preparing the cathode layer with high mass loading using dry processing, according to any of the embodiments described above. Further, the strain-hardening property of the thin-film sulfide solid-state electrolyte improves cycling performance.

### EXAMPLES

The present method is further described in connection with the following laboratory examples, which are intended to be non-limiting.

A high-energy-density all-solid-state Si|LPSCl|NMC811 battery cell was fabricated as follows. Solid electrolyte films were fabricated using a mixture of poly(isobutylene) binder (MW ~1270 g/mol) and argyrodite powder at a 5:95 weight ratio. A slurry composition was prepared with this mixture. The slurry composition consisted of 54 wt. % solids and the remaining 46 wt. % as toluene solvent. This slurry was subjected to ball-milling with zirconia milling media at a low rotational speed for 18 hours. After milling, the slurry was transferred back into an Ar-filled glovebox. Utilizing a doctor-blading technique, the slurry was cast onto a nonstick mylar sheet and left to air dry at ambient conditions. The resulting film was then enclosed between two mylar sheets and removed from the glovebox for calendaring via cold pressing at 25° C. The film thickness was progressively reduced by multiple passes through the cold roller press with increasing shim thickness, all within a sealed, airtight bag. The densified films were immediately returned to the glovebox and subsequently dried under vacuum overnight to ensure thorough removal of residual solvents before use.

The Si anode was fabricated using μmSi and polyvinylidene fluoride (PVDF) binder mixed at a weight ratio of 99.9:0.1 in an NMP solvent solution. This mixture was prepared in a vial to achieve a binder concentration of 0.1% and stirred using a magnetic stirrer for 24 hours. Subsequently, the resulting slurry was transferred onto a copper foil and spread evenly using a doctor blade to cast the film. The coated foil was then dried on a hotplate at 70° C., followed by further drying in a vacuum oven at 80° C. for 2 hours to ensure complete removal of residual solvents. Finally, the film was punched with a 6 mm diameter punch to prepare the anode substrate.

The composite cathode was fabricated using a dry process within an argon-filled glovebox. LiNbO₃-coated NMC811 active material, LPSCl catholyte, vapor grown carbon fiber (VGCF), and polytetrafluoroethylene (PTFE) were combined in a weight ratio of 80:16:3:1. The homogenized composite mixture was then manually rolled into a film using a cylindrical roller. After rolling, the film was punched into discs having a diameter of 6 mm to form the cathode structure.

Cell experiments were carried out at ambient temperature utilizing PEEK cells with a 6 mm diameter. To assembly the cells, two electrolyte sheets, also 6 mm in diameter, were positioned within a mold and compressed at 20 bar to establish the LPSCl layer. The N/P (Negative to Positive) ratio for cell evaluation was set to 1.1 and maintained throughout the testing. The cathode composite was then applied to one side of this layer, and carbon-coated aluminum foil was employed as the current collector on this surface. The anode plate was placed on the opposite side, and the entire assembly was subjected to cold pressing at 60 bar for 3 minutes, followed by tightening to maintain a stack pressure of 30 MPa.

All processes related to fabrication and electrochemical testing were conducted inside an argon-filled glovebox to ensure an inert atmosphere.

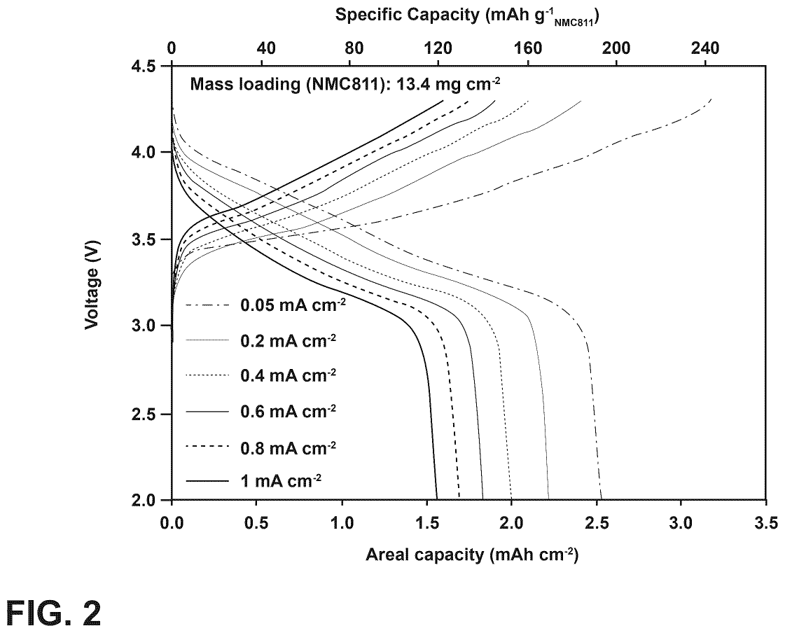

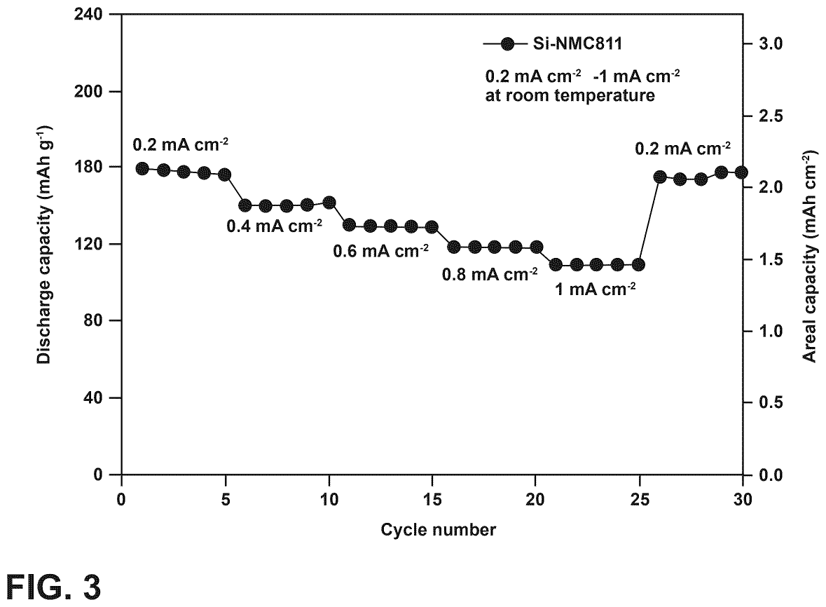

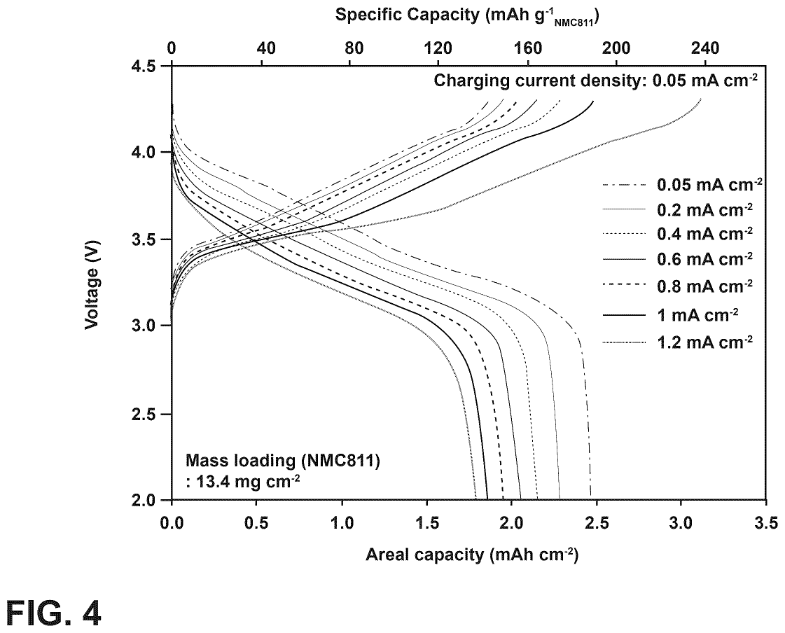

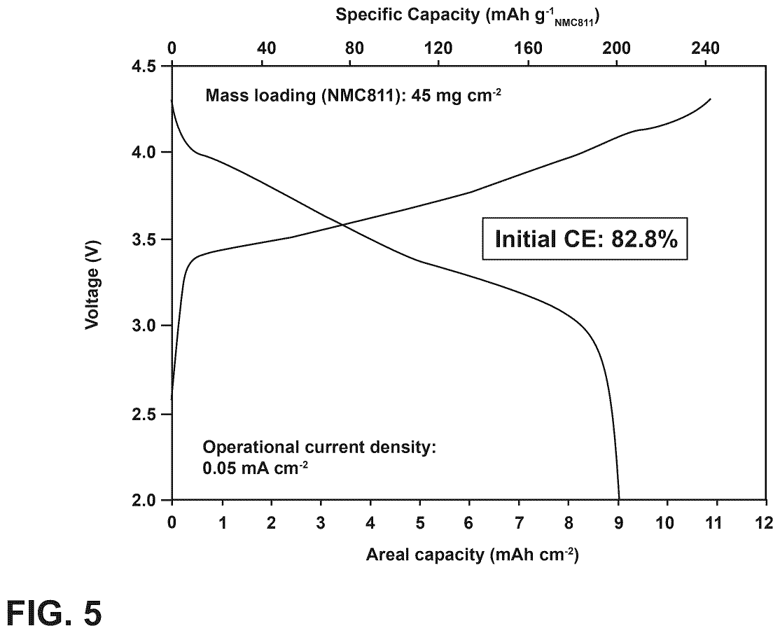

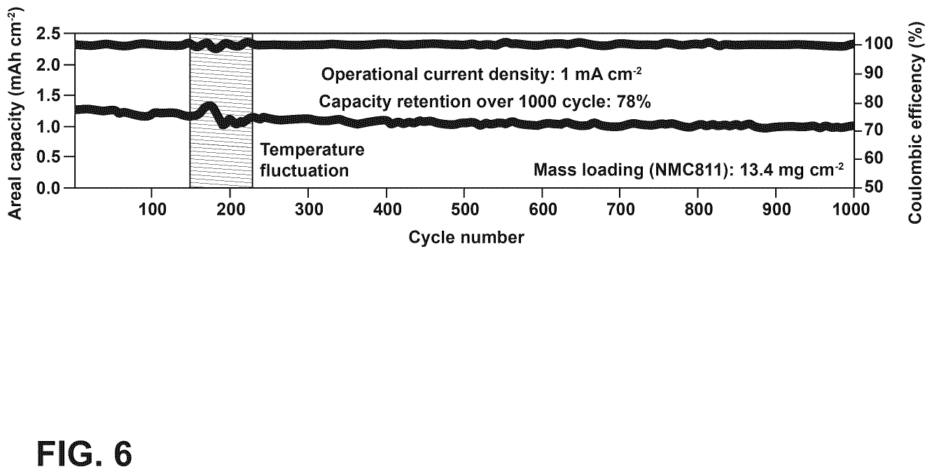

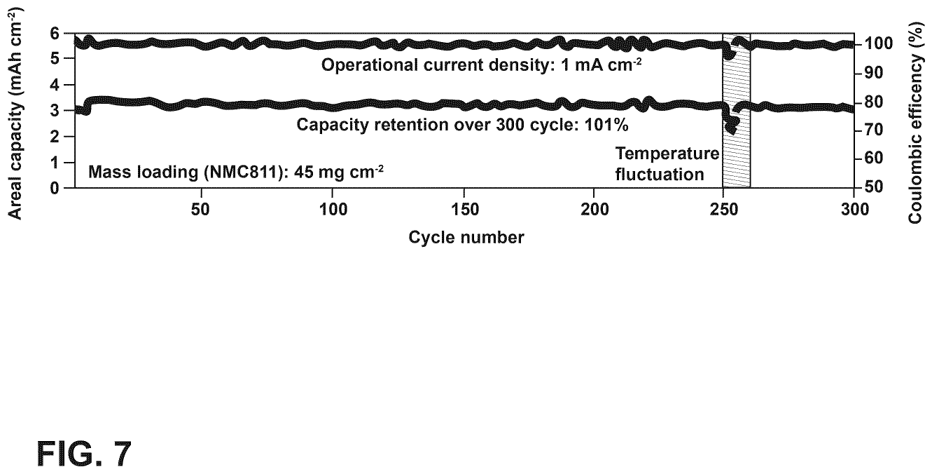

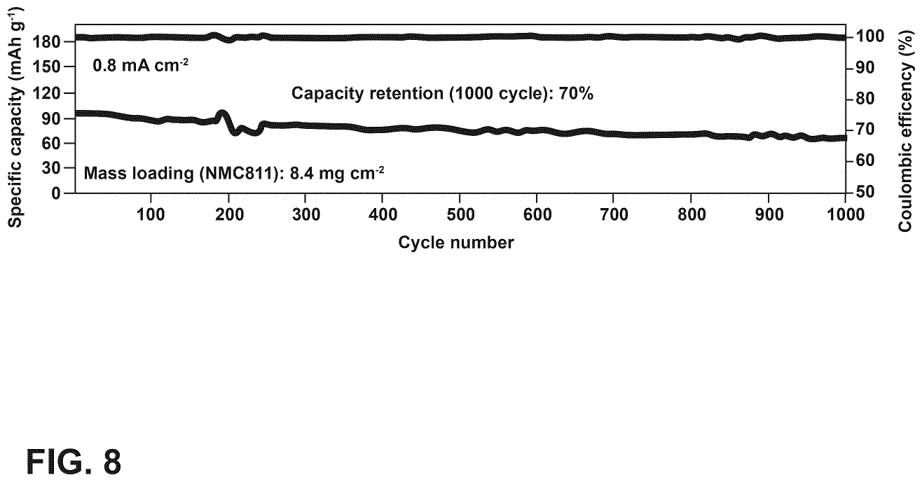

The electrochemical performance of the Si|LPSCl|NMC811 battery cell evaluated at 25° C. FIG. 2 shows the results obtained with an NMC 811 mass loading of 13.4 mg cm⁻², measured while gradually increasing the current density from 0.05 mA cm⁻² to 1 mA cm⁻². Previous studies have demonstrated that ASSBs using lithium metal experience cell failure due to dendrite formation at current exceeding 1 mA cm⁻². However, the present Si|LPSCl|NMC811 cell advantageously exhibited stable performance even at a current density of 1 mA cm⁻². To evaluate rate capability, cells with identical mass loading were tested sequentially at increasing current densities (0.2, 0.4, 0.6, 0.8, and 1 mA cm⁻²) each applied for five cycles. The results shown in FIG. 3 demonstrated stable operation across all tested current ranges. This performance highlights the robustness of the present cell design under varying electrical demands, ensuring its suitability for diverse applications. FIG. 4 shows the voltage profile for the present Si|LPSCl|NMC 811 cell with an NMC 811 mass loading of 13.4 mg cm⁻², where the charging current density was fixed at 0.05 mA cm⁻² and the discharging current density was progressively increased from 0.05 mA cm⁻² to 1.2 mA cm⁻² for each cycle. When compared to the results of a cell with the same mass loading in FIG. 2, it is evident that the cell exhibited relatively higher areal capacity at high current densities. FIG. 5 shows the voltage profile of the first cycle at 0.05 mA cm⁻² for the present Si|LPSCl|NMC811 cell with an NMC811 mass loading of 45 mg cm⁻². Even with this relatively high mass loading, the present system operated stably, achieving an initial coulombic efficiency of 82.8% and a discharge capacity of 9 mAh cm⁻². Considering the mass of the silicon anode, solid electrolyte, and cathode composite, the cell demonstrated a high material-specific energy density of approximately 381 Wh kg⁻¹. To evaluate the stability of cells with relatively low and high mass loading levels of 13.4 mg cm⁻² and 45 mg cm⁻², respectively, their stability was measured at a current density of 1 mA cm⁻² as shown in FIGS. 6 and 7. The cell with an NMC 811 mass loading of 13.4 mg cm⁻² operated stably for 1,000 cycles, showing 78% capacity retention. Between approximately 150 and 230 cycles, the cell exhibited some instability due to fluctuations in the lab temperature, but the electrochemical performance stabilized once the temperature normalized. The results from cycling a cell with an NMC 811 mass loading of 8.4 mg cm⁻² at 0.8 mA cm⁻² for 1000 cycles are shown in FIG. 8. This cell demonstrated 70% capacity retention over 1000 cycles, affirming the stability of the present system. The present cell with an NMC811 mass loading of 45 mg cm⁻² operated at a current density of 1 mA cm⁻² and maintained 101% capacity retention over 200 cycles without capacity fading. Notably, this cell maintained a stable areal capacity of over 3 mAh cm⁻² during operation. Similarly, this cell was temporarily affected by laboratory temperature fluctuations during cycles 250 to 260; however, it resumed normal operation once the temperature stabilized. This results demonstrated that the present system is capable of withstanding temporary temperature changes. One critical factor that must be considered is the proportion of active materials within the cathode composite. This ratio significantly influences the overall performance of the battery, impacting key parameters such as energy density, capacity, and stability during charge and discharge cycles. Optimal adjustment of this proportion is essential to balance the theoretical advantages of high active material content with practical operational challenges, ensuring the battery achieves both high efficiency and long-term reliability. While theoretically maximizing the proportion of the active material NMC811 within the cathode composite could enhance the areal capacity and thus maximize the energy density, practical considerations such as the flow of charge through the included electrolyte and carbon fiber must also be considered. Accordingly, 80% active material content was chosen for the composite. A cathode containing 90% active material was also comparatively tested. This cell configuration, with an NMC mass loading of 45 mg cm⁻², exhibited an initial coulombic efficiency of only 77.3%, and significant capacity fading was observed during operation. Therefore, the maximum proportion of active material that could demonstrate normal performance was set at 80%, and all experiments were conducted under this condition.

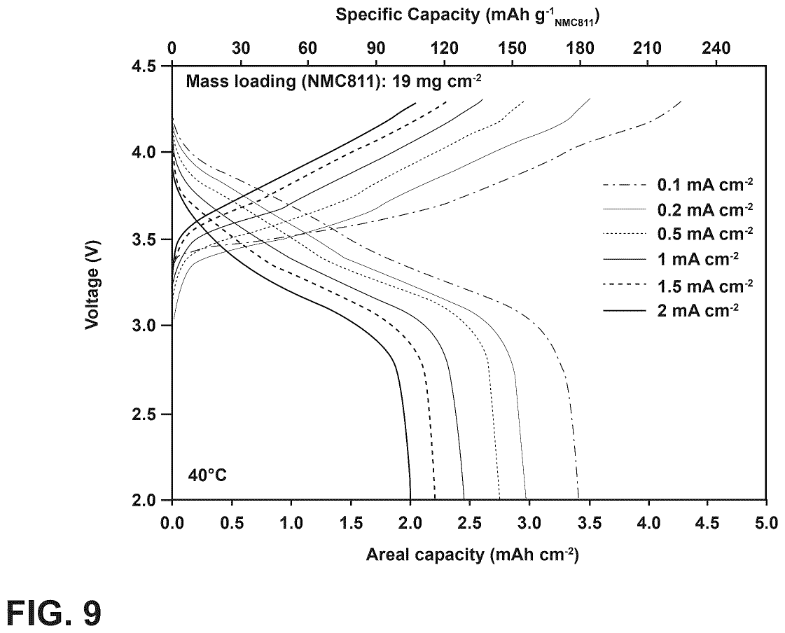

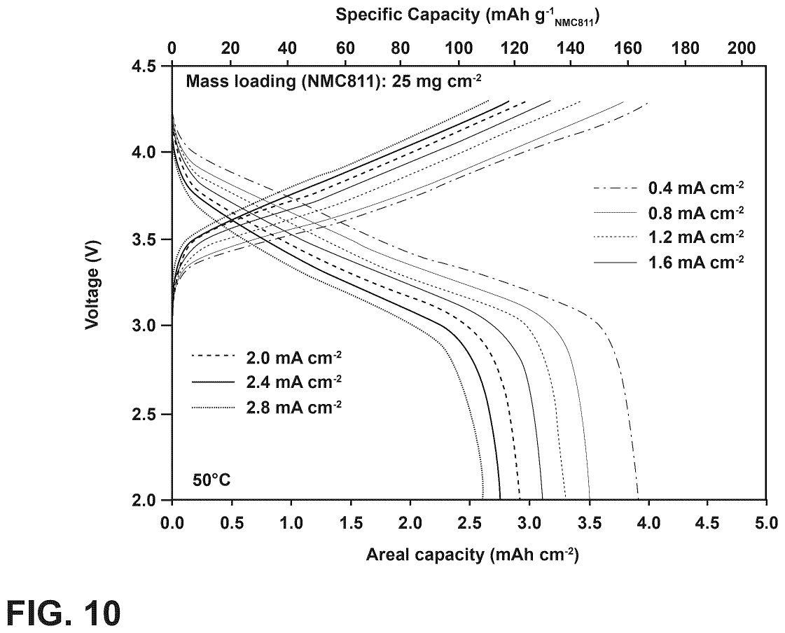

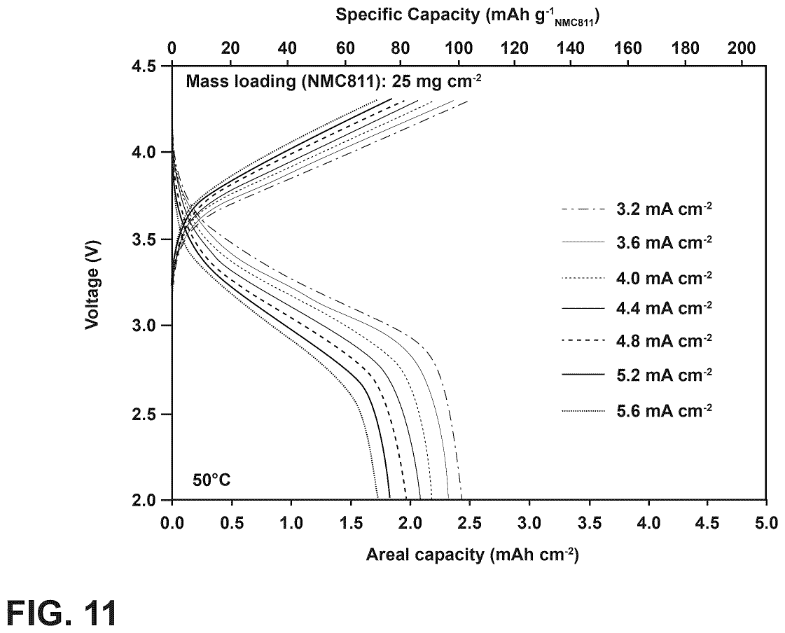

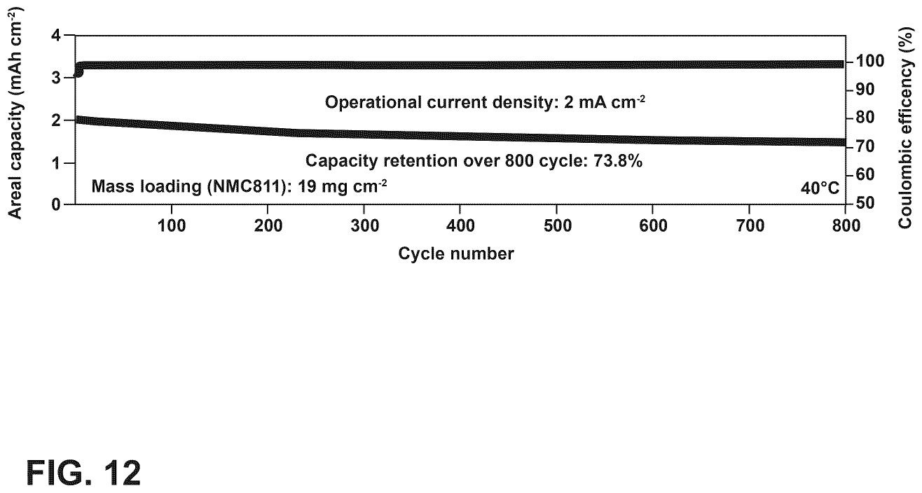

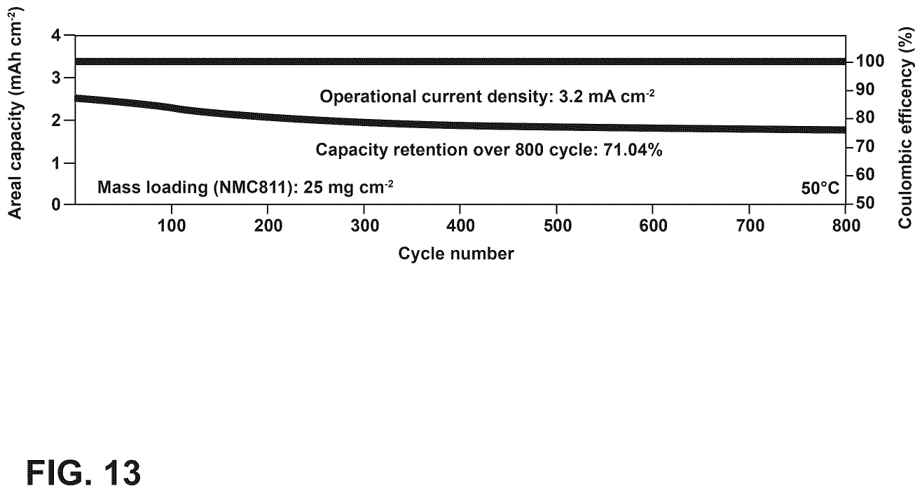

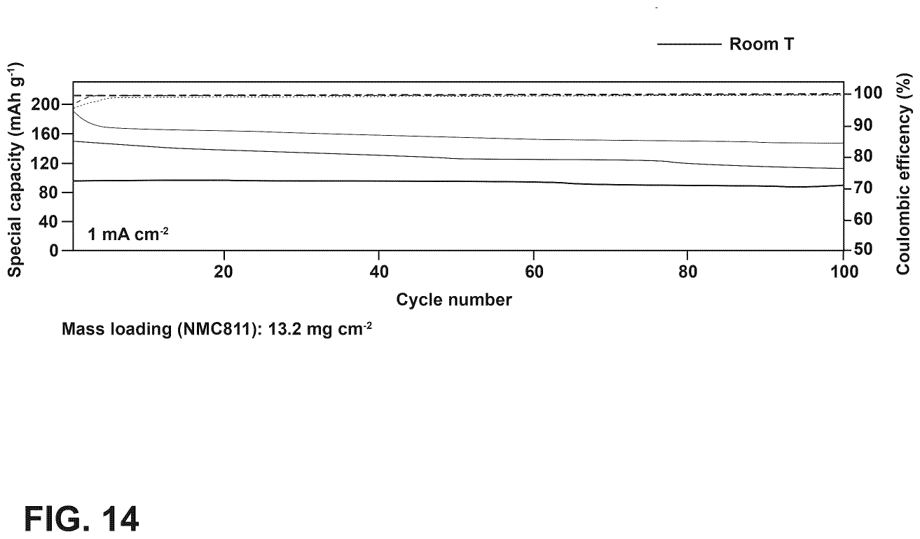

To evaluate electrochemical performance at elevated temperatures, the present Si|LPSCl|NMC 811 cell was evaluated at 40° C. and 50° C. FIG. 9 shows the voltage profile of the present Si|LPSCl|NMC 811 cell with an NMC 811 mass loading of 19 mg cm⁻², measured while increasing the operational current density from 0.1 mA cm⁻² to 2 mA cm⁻². The cell demonstrated stable operation without failure, even at the relatively high current density of 2 mA cm⁻². FIG. 10 shows the results for the present Si|LPSCl|NMC 811 cell with an NMC 811 mass loading of 25 mg cm⁻², measured as the current density was increased from 0.4 mA cm⁻² to 2.8 mA cm⁻². FIG. 11 shows the voltage profile as the current density was further increased from 3.2 mA cm⁻² to 5.6 mA cm⁻². It should be noted that the cell used for this measurement underwent two formation cycles at 25° C. with a current density of 0.05 mA cm⁻² prior to operation, before being transferred to a 50° C. oven for evaluation. As indicated by the results, the present system operated without failure even at the high current density of 5.6 mA cm⁻². FIG. 12 displays the long cycle stability results for the present Si|LPSCl|NMC 811 cell with an NMC811 mass loading of 19 mg cm⁻², evaluated at 40° C. This cell was measured at a current density of 2 mA cm⁻², demonstrating a capacity retention of 73.8% over 800 cycles. FIG. 13 shows the long-term cycling stability of the present Si|LPSCl|NMC 811 cell at 50° C. with an NMC811 mass loading of 25 mg cm⁻². This cell initially exhibited an areal capacity of approximately 2.5 mAh cm⁻² and retained 71.04 % of its capacity after 800 cycles. To comparatively assess the performance of the present Si|LPSCl|NMC811 cell at elevated temperatures, cells with identical mass loadings were prepared and cycled 100 times at current density of 1 mA cm⁻² at both 40° C. and 50° C. As shown in FIG. 14, during initial cycling the Si|LPSCl|NMC 811 cell exhibited a discharge capacity of 94.91 mAh g⁻¹ at 25° C., compared to 149.07 mAh g⁻¹ at 40° C. and 186.33 mAh g−1 at 50° C., indicating that higher temperatures promote an increased initial discharge capacity. However, while the cell retained approximately 94.96% of its capacity over 100 cycles at 25° C., it showed relatively lower capacity retention of 75.68% and 78.58% at 40° C. and 50° C., respectively. Also, the cells initially exhibited lower coulombic efficiency at 40° C. and 50° C., which increased to nearly 100% after 3 or 5 cycles.

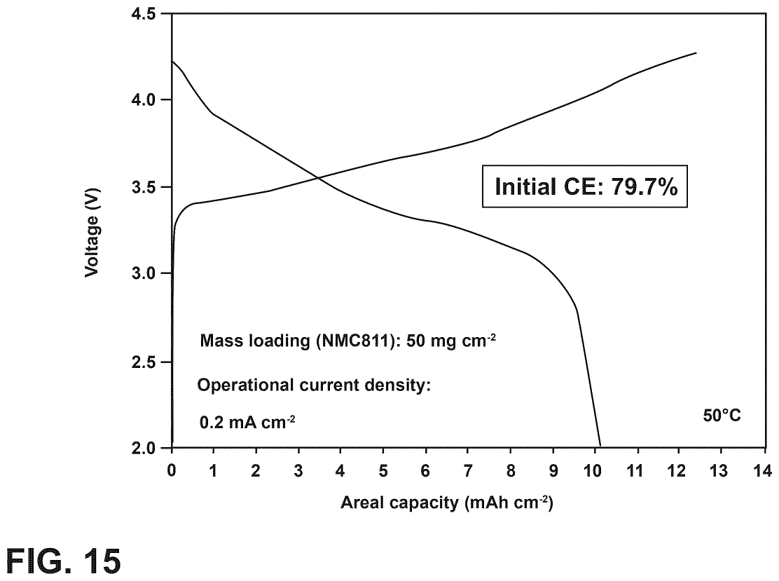

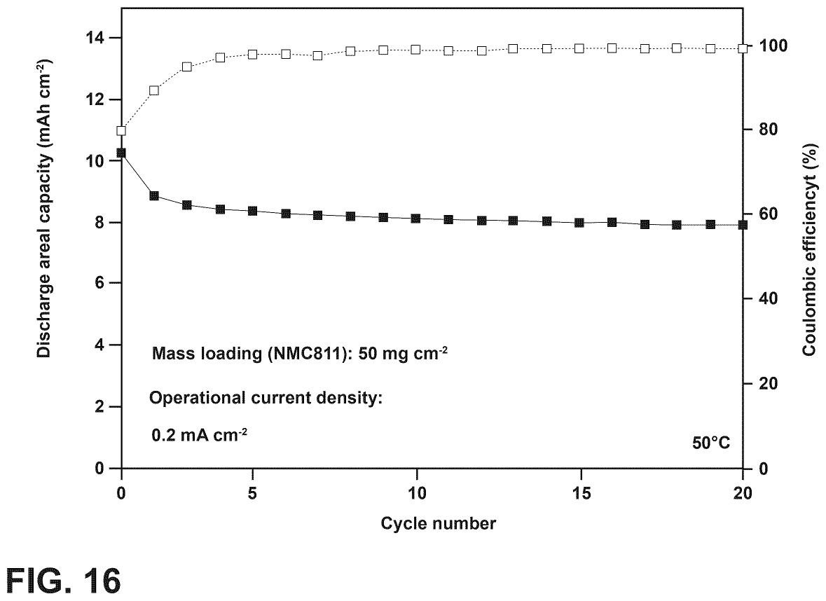

To demonstrate higher energy density, a cell with an NMC 811 mass loading of 50 mg cm⁻² was prepared and operated it at 50° C. with a current density of 0.2 mA cm⁻². The initial cycle voltage profile shown in FIG. 15 indicates that this cell achieved an areal capacity of 10 mAh cm⁻² with an initial coulombic efficiency of 79.7%. Based on the weight of the Si anode, electrolyte, and cathode composite, the specific energy density was calculated to be 400 Wh kg⁻¹. Furthermore, as shown in FIG. 16, the cell operated stably for 20 cycles and maintained a high areal capacity of approximately 8 mAh cm⁻² even after 20 cycles.

At 25° C. and 50° C., the energy densities achieved at the material level were 381 Wh kg⁻¹ and 400 Wh kg⁻¹, respectively, representing the highest values demonstrated to date among systems utilizing sulfide type ASSBs and silicon anodes. These results can be compared with previous studies that achieved energy densities above 200 Wh kg⁻¹ but no greater than approximately 300 Wh kg⁻¹ using sulfide ASSBs and silicon anodes. The present Si|LPSCl|NMC811 cell achieved a general energy density of at least 350 Wh kg⁻¹ at both 25° C. and 50° C., surpassing the values obtained in by previous cells.

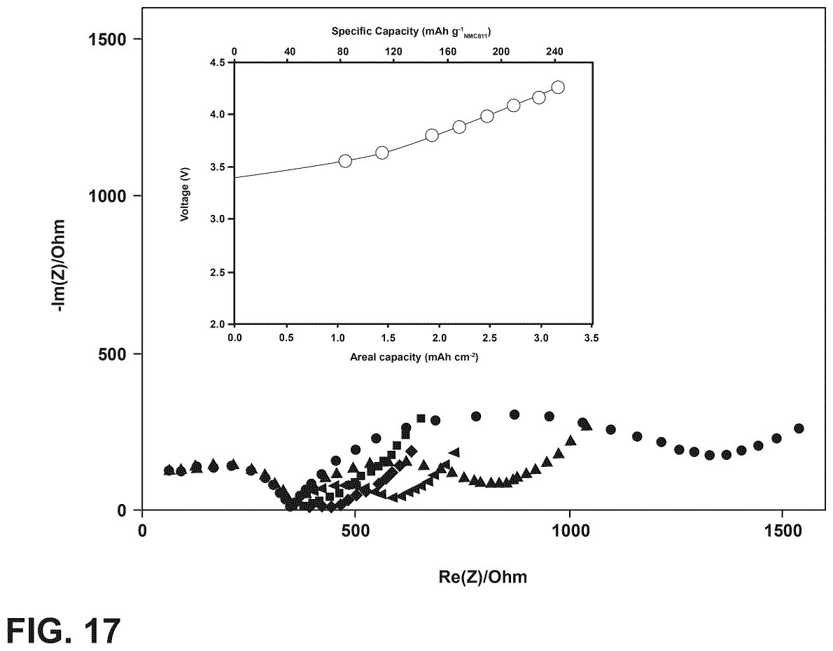

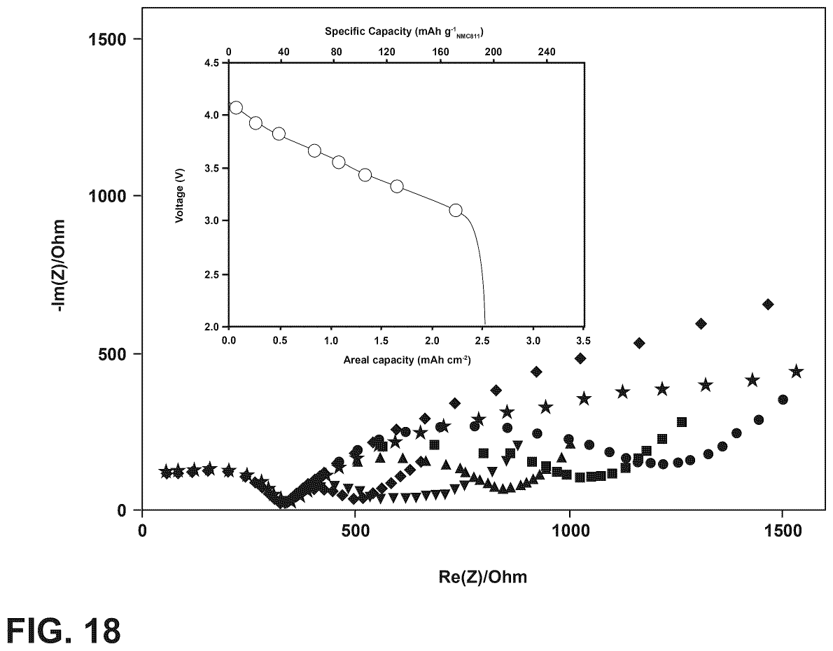

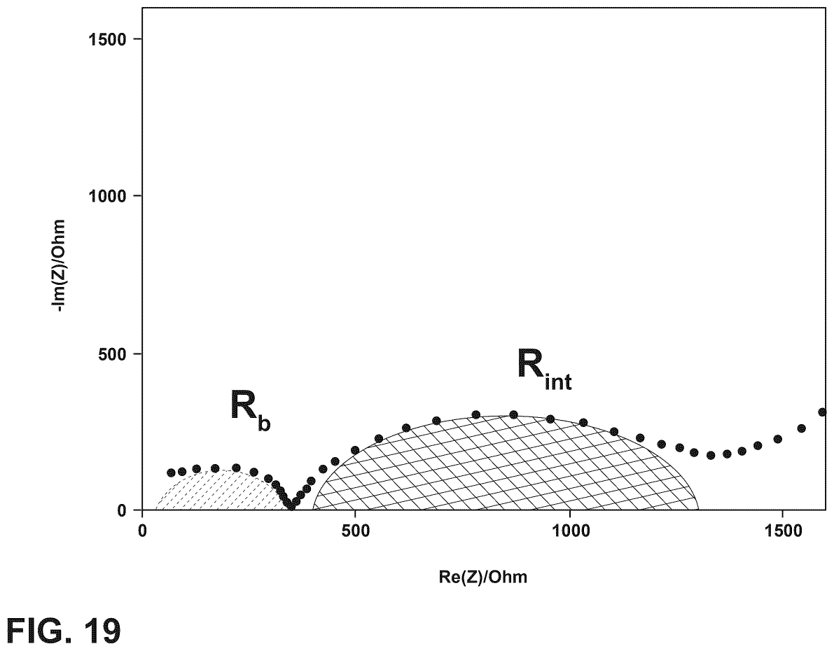

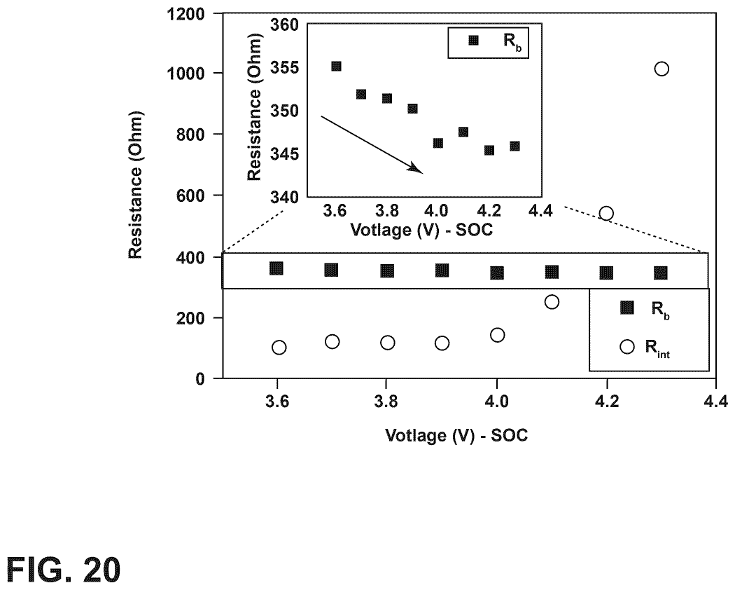

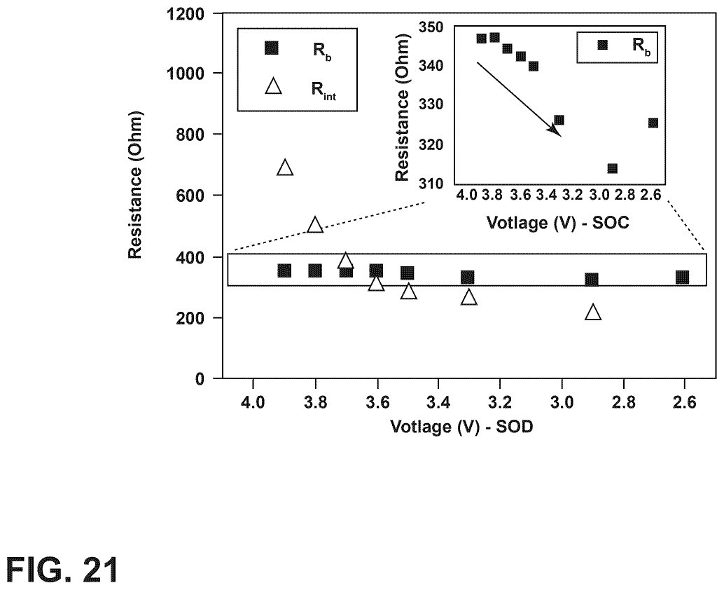

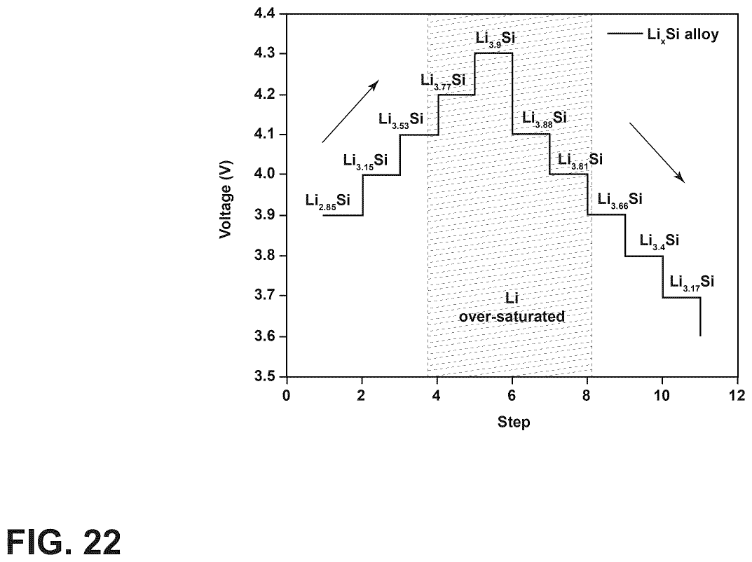

The interfacial resistance changes during the state-of-charge (SOC) and state of discharge (SOD) were monitored by conducting two electrode time-resolved electrochemical impedance spectroscopy (EIS) as shown in FIGS. 17 and 18. Only one semi-circle was observed among all spectral after the inflection point at high frequency range. This indicates significant impedance convolution from both anode and cathode contributions, making interpretation of loss contributor hard to apply in an established model. The obtained impedance spectral was fitted by equivalent circuit model (ECM) as R_{b} and Rᵢₙₜ to initialize the quantitative analysis as shown in FIG. 19. R_{b} refers to bulk and grain boundary resistances in thin film LPSCl, while Rᵢₙₜ represents the total interfacial resistance across the cell. Q accounts for constant phase element (CPE), usually applied when fitting into non-ideal capacitances. The corresponding values derived from ECM fitting were plotted against the voltage under charging (as shown in FIG. 20) and discharging (as shown in FIG. 21) processes. R_{b} steadily decreased during the lithiation process, suggesting a consolidation of the thin film LPSCl. This may be attributed to LiₓSi alloy volume expansion that compresses the LPSCl to a denser form. On the other hand, Rᵢₙₜ stabilized at the beginning from 3.6 V to 3.9 V and registered around 110 Ohm. But it sharply grew from 117.3 Ohm (4.0 V) to 1014 Ohm (4.3 V) afterwards. This sharp impedance growth may be related “over saturation of Li” beyond silicon interstitial sites. To investigate this, capacity was tracked during the lithiation process and the mole ratio between Li to Si in the anode was calculated at different steps shown in FIG. 22 (assuming only one Li—Si alloy phase forms in the entire process, and lithium directly diffuses in Si sites instead of accumulating before maximum lithiation state). Based on the calculations, Li_{3.53}Si alloy forms at 4.1 V and saturates at an exceeding value of Li_{3.77}Si at 4.2 V. Note that Li₁₅Si₄ (Li_{3.75}Si) is the maximum lithiation state of silicon at 25° C. Symmetrically, the delithiation process presents a fast diminishing of Rᵢₙₜ from 3.9 V to 3.6 V. This involves two steps. first is the consumption of over saturated lithium; and second, the metastable phase Li₁₅Si₄ transforms to a more stable phase, for example, Li₁₃Si₄. This helps to stabilize the SEI by forming a stable LiₓSi alloy and eliminating residual lithium.

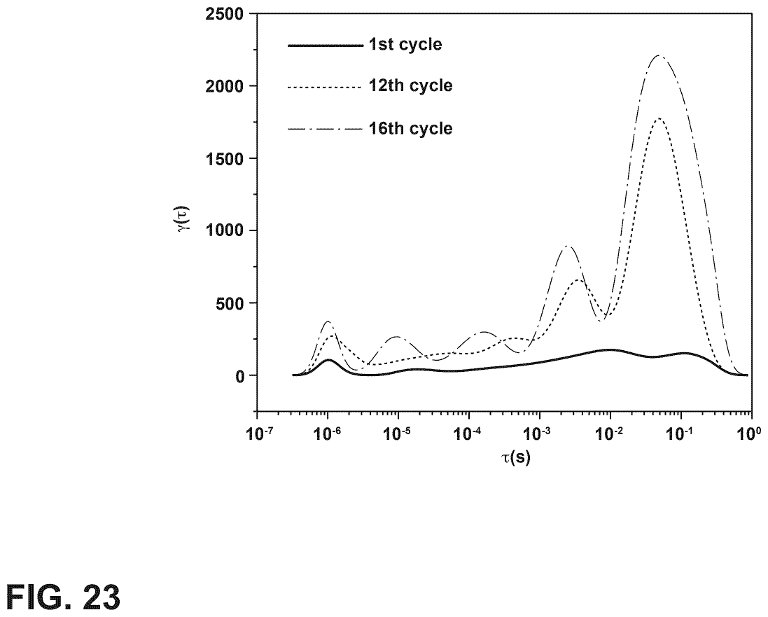

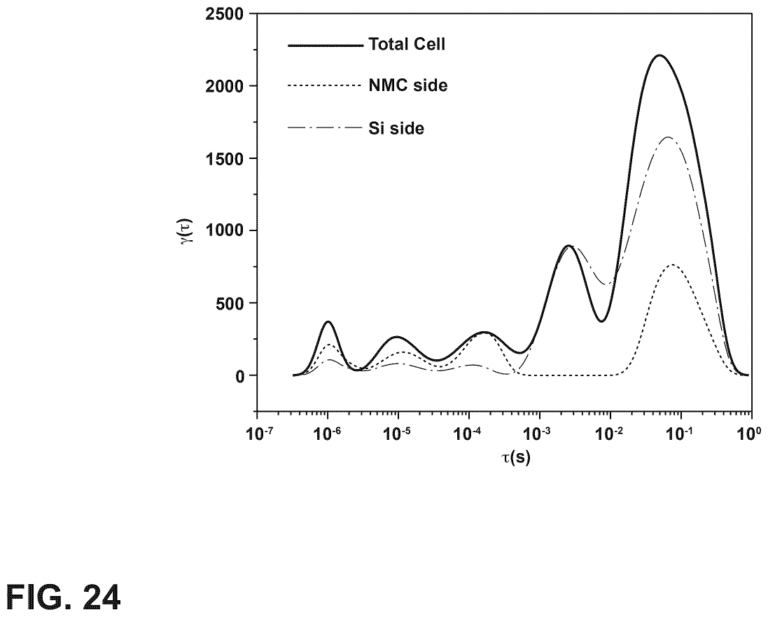

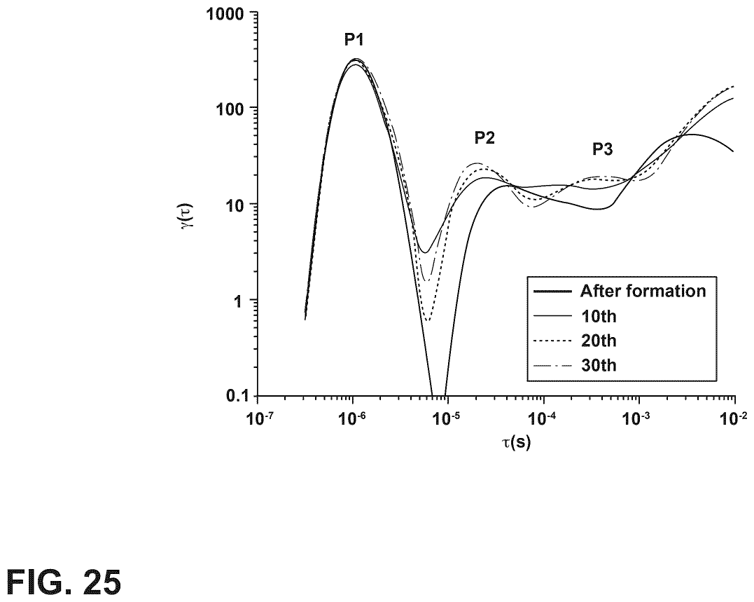

To determine whether the Si anode or NMC cathode dominates the loss, three electrode in-situ EIS were conducted as a function of cycle number in a customized cell. Particularly, a specially designed three-electrode cell with a unique structure was utilized. For the measurements, the counter electrode was connected to the Si electrode side, the reference electrode to the solid electrolyte, and the working electrode to the NMC electrode side. Impedance was then analyzed over the course of cycling. To adapt to the three-electrode cell, larger LPSCl disc films with cell area roughly of 1.131 cm² were used. To deeply understand the electrochemical processes in the EIS spectra of the cycling aging in the three-electrode cell, distribution relaxation time (DRT) analysis was performed on the 1st, 12th, and 16th cycles for total cell impedance as shown in FIG. 23. The impedance response from interfacial processes become more distinct at the 16th cycle, suggesting thin sheet sulfide solid state cells require the extensive formation stage to stabilize interphase over cycling. To determine the limiting factor for the electrochemical process, DRT analysis for three electrode impedance was performed as shown in FIG. 24, which revealed five different phases (P1-P5) in 10⁶ Hz to 10⁰ frequency range. At low frequency, P4 appears only in the Si anode at 10-3 to 10-2 s, which may be associated with silicon-silicon particle contact. Charge transfer resistance (P5) on both Si and NMC side (10⁻¹ s) dominates the entire loss. The high charge transfer impedance in the NMC side presents a nuanced issue especially over cycling aging. At high voltage, the fully oxidized Ni⁴⁺ tends to react with sulfide electrolyte, which triggers severe parasitic reactions. The ever-generated byproducts partially block the electrical conducting path, which increases charge transfer impedance of the NMC composite cathode. On the other hand, the primary contribution of interfacial impedance originates from the NMC side in P2 and P3 (10⁻³ to 10⁻⁵ s), indicating CEI owns more pronounced issues of compositions and thickness than SET in a thin sheet sulfide solid state battery. This result suggests that while a stable SET is formed between Si and LPSCl during the entire cycling, CEI evolves constantly during the first 30 cycles contributing to unstable interphase which adversely affects the electrochemical performance. FIG. 25 shows the DRT analysis results for the total cell, obtained after the initial formation cycle and at the 10th, 20th, and 30th cycles. While no significant changes are observed in P1, a gradual increase in P2 and P3 was evident with cycling. This observation supports the premise of evolution of CEI formation on the cathode side for the first 30 cycle during operation.

The effects of the NMC cathode side were analyzed in further detail. Given the fact that lithium-ion diffusion is strongly dependent on pathway distance where Si anode is roughly 10 μm thick which is at least 1 order of magnitude lower than the NMC cathode. Therefore, lithium diffusion is preferably limited on the NMC cathode side. To quantify the apparent diffusion coefficient on the cathode, GITT was applied to monitor the lithium-ion apparent diffusion coefficient as a function of SOC or SOD. Initially, lithium diffused quickly during the charging step, registering at 10^{-0.95} cm²S⁻¹. This suggests an initial larger stock lithium-ion concentration with low vacancies of NMC benefits the lithium diffusion process. This apparent diffusion coefficient value continuously dropped to 10⁻¹⁰ cm²S⁻¹. This results in a slower diffusion process in the cathode. From 50% to 80% SOC, the diffusion process reached a plateau, indicating an “equilibrium” between the vacancies and concentration gradient of lithium ion. At the end of charging process, due to minimal lithium concentration, the diffusion process slowed down. The GITT confirmed the overall effective diffusion process in the initial cycle, supporting the limiting factor of the cell being attributable to CEI evolution and charge transfer impedance.

To better understand the results obtained from EIS analysis, qualitative changes at the interface between the electrolyte and the Si negative electrode during charging and discharging were analyzed ex-situ using Raman spectroscopy. The results indicated that throughout all cycling processes, the Si/LPSCl interface remained clean without structural breakdown due to decomposition of LPSCl, suggesting that a stable SEI layer forms on the interface, preventing decomposition of the solid electrolyte during operation. This result is consistent with the DRT analysis, which indicated that the resistance of the stable SEI is not dominant. Previous studies investigating the structural evolution at the interface between lithium metal and LPSCl have shown that lithium metal can induce decomposition of the solid electrolyte due to unstable SEI formation, resulting in a rough interface. In contrast, the present use of a Si layer in the battery cells herein, when applied together with a sheet-type LPSCl layer, demonstrated the formation of a stable interface. Focusing on the changes in peaks related to Si during the charging and discharging process, the lithiated Si peaks and regions at 200-300 cm⁻¹ began to expand significantly at 4.0 V. At the fully charged state of 4.3 V, amorphous Si was clearly detected, with lithiated Si peaks in the 200-300 cm⁻¹ range becoming dominant and the lithiated Si peak at 367 cm⁻¹ clearly appearing. After discharging back to 3.6 V, the prominent lithiated Si peaks at 200-250 cm⁻¹ and 367 cm⁻¹ , as well as the amorphous Si peak, disappeared. Further, in a pristine sample, LPSCl is observed to be evenly distributed throughout the electrolyte layer and catholyte. However, after charging, the catholyte undergoes decomposition, resulting in the formation of a secondary phase. This finding supports the premise of unstable CEI formation as a contributing factor.

Raman mapping revealed that while the catholyte on the cathode side was extensively decomposed, leading to the formation of an unstable CEI, a stable SEI was formed between silicon and LPSCl on the anode side, effectively preventing further decomposition of LPSCl during operation. These findings align with the observations from DRT analysis. However, as the Raman mapping shows phases at a resolution of 1 μm×1 μm, additional surface analysis using X-ray photoelectron spectroscopy (XPS) was conducted to identify the specific materials formed at the anode/SSE interfaces on a microscopic scale. The analysis revealed that the major products forming on the cathode side after operation include P₂S₅ and NbOCl₃, while the primary products on the anode side were identified as Li₂S, LiCl, and LiₓP. The O 1s XPS analysis of the cathode demonstrated that peaks related to lattice oxygen disappeared after the first charge cycle due to oxygen evolution reactions. Given the 10 nm LiNbO₃ (LNO) coating layer on the NMC811 used herein, the XPS surface analysis indicated that oxygen evolution originated from the LNO layer. The increase in the portion of peaks related to Nb—O bonding observed on the surface after the charging process indicated the formation of a new phase, such as NbOCl₃. To enable a more detailed analysis, the Cl 2p spectrum of the cathode side was also examined over a single cycle. At the pristine stage, two peaks could be found at 198.5 and 200 eV that could be assigned to LPSCl and LiCl, respectively, due to the intensity difference and the more electron dense Cl⁻ in LPSCl. After the charging, a new peak was identified with higher binding energy at 202 eV. Such a positive binding energy indicated the relatively lower energy density of the new formed Cl-species. Also, the new species was electrochemically irreversible as still existed after cell discharge. The S 2p analysis of the cathode confirmed a significant increase in P₂S₅ content during the first cycle, corroborating the decomposition of the catholyte into P₂S₅. These results demonstrated that the catholyte predominantly decomposed into these products during operation. For the anode side, the XPS analysis of the pristine sample was limited by the silicon covering the surface, which obscured the SEI. Consequently, the silicon layer was removed after charge and discharge cycles to facilitate SEI analysis. The Li 1s spectrum of the anode showed metallic lithium in its overlithiated state, which disappeared after discharge, leaving behind LiCl and Li₂S. The S 2p spectrum revealed that the SEI primarily consisted of Li₂S. Collectively, Raman mapping and XPS analyses confirmed that the interlayer between silicon and the LPSCl electrolyte formed a stable SET composed of Li₂S, LiCl, and LiₓP. This interlayer effectively prevented further electrolyte decomposition during operation, demonstrating its critical role in enhancing the stability of the system.

To further elucidate the performance degradation caused by the cathode and CEI, the cathode particles were analyzed and compared with pristine particles after long-term cycling. The results confirmed that Ni and O elements were uniformly distributed within the particle, with Nb elements forming a very thin and even layer on the surface. In contrast, after 1000 cycles the NMC811 particles had severe cracks inside the NMC particles, with the oxygen element concentrated within the cracks. This suggested that OER induced the migration of oxygen elements from the bulk to the surface, which was identified as the cause of the cracks. Also, oxygen elements were concentrated on the overall surface of the NMC811 particles, and Nb elements were unevenly distributed, forming agglomerates. These results strongly corroborate the formation of an unstable CEI, providing clear visual evidence.

To validate the instability of the LNO-NMC cathode, density functional theory (DFT) simulation was performed to further understand the physiochemical properties of LiNbO₃ and its possible degradation product, NbOCl₃. B3LYP function, 6-31+G* basis set for main group elements (Li, O, and Cl), and def2-TZVP basis set for Nb were used to simulate the geometries for LiNbO₃ and NbOCl₃ at the single molecule level using the Gaussian 16 package. We first analyzed the highest occupied molecular orbitals (HOMO) of these two compounds to access their oxidation stabilities. HOMO was located at the Nb—O or Nb—Cl in the two Nb compounds. However, the HOMO energy level for NbOCl₃ is −6.12 eV, which is 1.5 times higher than that for LiNbO₃ at ~4.22 eV. Such a low HOMO level indicates a more stable property of NbOCl₃ under oxidative conditions. Meanwhile, we also simulated the XPS spectra from DFT results. For NbOCl₃, the simulated XPS spectrum in the 192 to 203 eV range showed a main peak at 201 eV, which is very closed to what was observed in the experimental XPS spectra. On the other hand, the simulated XPS spectrum for LiNbO 3 in the 525 to 535 eV range showed two peaks close to 526 eV.

Based on the XPS and DFT results, it appears that the LiNbO₃ coating layer was electrochemically decomposed under the cell charge process. The LNO coating layer went through oxygen evolution reaction (OER) with LPSCl. On the other side, the Li-ion was lithiated to the anode side as lithium metal. Once the LNO was consumed, the cell reached a stable state with the as-formed interfacial layers. Further, it appears that the overall formation of the CEI within the cathode layer acts as a significant factor in degrading electrochemical performance during operation. Specifically, the decomposition products, such as NbOCl₃ and P₂S₅, were identified and corroborated by XPS and DFT results. Furthermore, on the anode side, a stable SEI containing Li₂S, LiₓP, and LiCl was formed at the silicon-LPSCl interface during the initial stages of operation, effectively protecting against electrochemical performance degradation, as supported by XPS and Raman analyses.

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

What is claimed is:

1. A method of fabricating an all-solid-state battery, the method comprising:
forming a silicon-based anode layer by wet processing a first mixture including microsilicon particles having an average particle size in a range of 0.1 to 100 μm, the silicon-based anode layer having a thickness in a range of from 1 to 200 μm;
forming a sulfide solid-state electrolyte (SSE) film by wet or dry processing a second mixture, the SSE film having a thickness in a range of from 0.5 to 100 μm;
forming a cathode layer by dry processing a third mixture, the cathode layer having a thickness in a range of from 1 to 200 μm; and
combining the silicon-based anode layer, the sulfide SSE film, and the cathode layer.

2. The method of claim 1, wherein the first mixture further includes lithium added to the microsilicon particles to form lithium-silicon alloy particles, and a molar ratio of lithium to microsilicon is from greater than 0 to 90:10.

3. The method of claim 1, wherein the step of combining the silicon-based anode layer, the sulfide SSE film, and the cathode layer further includes one of:
i) laminating the silicon-based anode layer, the sulfide SSE film, and the cathode layer together;
ii) press-combining two of the silicon-based anode layer, the sulfide SSE film, and the cathode layer together, and then adding the other of the silicon-based anode layer, the sulfide SSE film, and the cathode layer; or
iii) transfer-printing the sulfide SSE film onto either the silicon-based anode layer or the cathode layer, and then adding to other of the silicon-based anode layer or the cathode layer.

4. The method of claim 1, wherein the first mixture includes further includes a polymeric binder comprising a fluoropolymer component, wherein a CF2-to-CH2 molar ratio of the binder is from greater than 0:100 to 100:0.

5. The method of claim 1, wherein the first mixture further includes a solvent that comprises one or more of an aqueous solvent, a polar aprotic organic solvent, and an ether solvent.

6. The method of claim 5, wherein the solvent is selected from the group consisting of N-methyl-2-pyrrolidone (NMP), N,N-dimethylformamide (DMF), N,N-dimethylacetamide (DMAc), dimethyl sulfoxide (DMSO), water (H₂O), 1,2-demethoxyethane (DME), 1,3-dioxolane (DOL), diethylene glycol dimethyl ether (diglyme), triethylene glycol dimethyl ether (triglyme), tetraethylene glycol dimethyl ether (tetraglyme), 2-methyltetrahydrofuran (2-MeTHF), tetrahydrofuran (THF), diethyl ether (DEE) and mixtures thereof.

7. The method of claim 1, wherein the microsilicon particles comprise at least 10 wt. % silicon and up to 99.9 wt. % silicon.

8. The method of claim 1, wherein the microsilicon particles have a broad particle size distribution such that D90/D10≥3.

9. The method of claim 1, wherein the step of wet processing the first mixture includes slurry casting the first mixture onto a substrate.

10. The method of claim 1, wherein the second mixture includes a binder selected from a group of nitrile butadiene rubber (NBR), hydrogenated nitrile butadiene rubber (HNBR), polyisobutylene (PIB), poly(butyl methacrylate) (PBMA), styrene-butadiene-styrene (SBS), styrene-ethylene/butylene-styrene (SEBS), and styrene-butadiene rubber (SBR).

11. The method of claim 1, wherein the second mixture includes argyrodite.

12. The method of claim 1, wherein the second mixture includes an anhydrous, nonpolar solvent or a low-polarity organic solvent.

13. The method of claim 12, wherein the solvent includes one or more of toluene, n-heptane, n-hexane, cyclohexane, decalin, a C10-C14 alkane, a xylene, anisole, isobutyl isobutyrate, mesitylene, ethylbenzene, and an isoparaffinic hydrocarbon.

14. The method of claim 1, wherein the step of wet processing the second mixture includes slurry casting the second mixture onto a substrate to obtain an intermediate film, and densifying the intermediate film by subjecting the intermediate film to a plurality of passes through a roller press at a temperature in a range of from approximately 20 to 700° C. to obtain the sulfide SSE film.

15. The method of claim 1, wherein the SSE film has a strain-hardening property such that an indentation stress increases with indentation strain over an indentation strain interval from 0.2 to 1.

16. The method of claim 15, wherein the strain-hardening property has a positive work hardening slope, dσ/dε>0, over at least 0.1 of the indentation strain within the interval from 0.2 to 1.

17. The method of claim 15, wherein the indentation stress at an indentation strain of 1 is at least 1.1 times the indentation stress at an indentation strain of 0.2.

18. The method of claim 1, wherein the third mixture includes:
i) a coated layered oxide cathode active material comprising a lithium nickel manganese cobalt oxide (NMC) of formula LiNiₓMn_{y}Co_{z}O₂, where x+y+z=1 and 0<x<1, the cathode active material having a surface coating comprising one of a lithium-containing inorganic coating layer, a lithium-containing metal oxide coating layer, or a niobium-containing lithium oxide coating layer;
ii) a sulfide catholyte comprising Li₆PS₅Cl (LPSCl);
iii) a conductive carbon material selected from a group of carbon fibers, vapor-grown carbon fibers, carbon black, acetylene black, Ketjenblack, graphite, graphene, carbon nanotubes, carbon nanofibers, and mixtures thereof; and
iv) a polymeric binder selected from a group of polytetrafluoroethylene (PTFE), poly(vinylidene fluoride) (PVDF), poly(vinylidene fluoride-co-hexafluoropropylene) (PVDF-HFP), fluorinated ethylene propylene (FEP), ethylene-tetrafluoroethylene (ETFE), nitrile butadiene rubber (NBR), hydrogenated nitrile butadiene rubber (HNBR), styrene-ethylene/butylene-styrene (SEBS), styrene-butadiene-styrene (SBS), polyisobutylene (PIB), poly(butyl methacrylate) (PBMA), and mixtures thereof.

19. The method of claim 18, wherein the third mixture comprises, based on a total weight:
i) approximately 50 to 95 wt. % of the coated layered oxide cathode active material;
ii) approximately 3 to 25 wt. % of the sulfide catholyte;
iii) approximately 0.5 to 10 wt. % of the conductive carbon material; and
iv) approximately 0.1 to 5 wt. % of the polymeric binder.

20. The method of claim 18, wherein the step of dry processing the third mixture comprises:
i) dry mixing the cathode active material, the sulfide catholyte material, the conductive carbon material, and the polymeric binder to form a first blended powder;
ii) homogenizing the first blended powder to form a homogenized composite;
iii) forming the homogenized composite into a free-standing film by rolling; and
iv) pressing the free-standing film to densify the film thereby forming a cathode film.

21. The method of claim 20, wherein the step of homogenizing the first blended powder comprises applying shear and/or compressive deformation to distribute the conductive carbon material and the polymeric binder substantially uniformly throughout the third mixture.

22. The method of claim 20, wherein:
i) the step of homogenizing the first blended powder is performed at a temperature in a range of from approximately −196 to 300° C.;
ii) the step of rolling the homogenized composite is performed at a temperature in a range of from approximately 15 to 120° C.; and
iii) the step of pressing the free-standing film is performed at a temperature in a range of from approximately 20 to 500° C. and at a pressure in a range of from approximately 1 MPa to 300 MPa for a time period in a range of from approximately 1 second to 60 minutes.

23. An all-solid-state battery obtained by the method of claim 1.

24. The all-solid-state battery of claim 23, having an energy density of at least approximately 300 Wh/kg at a temperature in a range of from approximately 25 to 200° C.
